(19) United States
(12) Patent Application Publication
(10) Pub. No.: US 2013/0327973 A1
(43) Pub. Date: Dec. 12, 2013

(54) Quantity Control Valve for Fuel Systems

(71) Applicant: Dieter Maier, Rettenberg (DE)

(72) Inventor: Dieter Maier, Rettenberg (DE)

(73) Assignee: Robert Bosch GmbH, Stuttgart (DE)

(21) Appl. No.: 13/883,743

(22) PCT Filed: Sep. 13, 2011
(86) PCT No.: PCT/EP2011/065821

§ 371 Date: Jul. 20, 2013

(30) Foreign Application Priority Data
Nov. 18, 2010 (DE) 102010044119.8

(51) Int. Cl. F02M 59/36

(52) U.S. Cl. CPC F02M 59/36
USPC 251/337

(57) ABSTRACT

A quantity control valve of a fuel system comprises an operating element, a valve element, which can be acted upon by the operating element against the force of a valve spring, at least one first housing portion, a guide portion formed on the first housing portion for guiding the operating element, and a valve seat formed on the first housing portion and interacting with the valve element. The first housing portion is produced integrally with the guide portion and the valve seat by powder injection molding.

### PRIOR ART

The invention concerns a quantity control valve according to the preamble of claim 1.

Quantity control valves, for example in a fuel system of an internal combustion engine, have been known on the market for some time. Quantity control valves are generally operated electromagnetically and are frequently part of a high pressure pump of the fuel system. The quantity control valve controls the fuel quantity flowing to a high pressure accumulator, from where fuel is conducted to the injectors of the internal combustion engine. An armature coupled to a valve needle of the quantity control valve can be moved by magnetic force, whereby the valve needle is actuated. The valve needle in turn acts on a valve plate. The valve plate can stop against a valve seat or be lifted from the valve seat. In this manner a fuel quantity of the internal combustion engine can be regulated. Usually quantity control valves comprise several elements to fulfill different functions, for example inter alia a needle guide, a fuel flow passage, a valve seat and a valve seat stop.

### DISCLOSURE OF THE INVENTION

The problem on which the invention is based is solved by a quantity control valve according to claim 1. Advantageous refinements are given in the subclaims. Features important to the invention are furthermore described in the description which follows and in the drawings, wherein the features may be important for the invention both alone and in various combinations without explicit reference being made to this.

The invention has the advantage that a quantity control valve of a fuel system is constructed more simply if several different elements are combined in a single component with the same function, which is produced by powder injection molding. Thus production steps can be saved, assembly errors and assembly tolerances minimized. Also the quality of the element produced integrally in this way can be tested already on the finished component before installation, avoiding fault costs. Because of the numbers of parts normally used in motor vehicle construction, despite initial process-technical costs such as for production of injection molding tools, this technology can be profitably applied and hence the overall costs reduced.

The invention is based on the consideration that a quantity control valve, to fulfill the numerous requirements, is formed with great differentiation. In particular many different types of element are joined together in the quantity control valve. According to the invention a first housing portion, together with a guide segment to guide an actuating element, and a valve seat cooperating with the valve element, is produced integrally in a process of powder injection molding.

Thus various different functions or elements are combined into a single component. The integral component performs firstly a part function of a housing or carrier element for the quantity control valve, and also the function of a radial plain bearing for radial guidance of the actuating element, and also the function of a valve seat on which a valve element controlled by the actuating element can rest. Here, press joints for mounting the quantity control valve can be saved, whereby also the dimensional accuracy can be improved and the durability extended.

An embodiment of the quantity control valve provides that the first housing portion has a pot-like cylindrical form and the guide segment is present at a cylindrical opening in a floor of the first housing portion. In this way the first housing portion can be designed substantially rotationally symmetrical, and the guide segment can be arranged correspondingly centrally, which is simple for production. In addition the floor in the region of the guide segment can have a greater axial thickness to improve the axial guidance.

The first housing portion is improved if passage openings for the fuel are present in the floor of the first housing portion. The integration of passage openings in the first housing portion allows a particularly compact and simple construction of the quantity control valve and saves corresponding working steps at another point. Here, thanks to injection powder molding, the cross section of the passage openings can have an almost arbitrary form. Where applicable the passage openings can also be designed as grooves.

Furthermore it is provided that the valve seat is formed by an axially extending annular web. Thus the valve seat, which is important for function of the quantity control valve, is also integrated in the first housing portion. Thus no additional elements are required which would have to be mounted separately.

The quantity control valve is further improved if the first housing portion comprises at least one axially extending connecting segment to create at least one press joint to at least one second housing portion. Thus it is possible to arrange the first housing portion on a second housing portion, and where applicable on further housing portions of the quantity control valve, without additional fixing elements being required. The axially extending connecting segments are here an integral part of the first housing portion. It is particularly favorable if the first housing portion has at least one connecting segment in both axial directions, so that further housing portions can be pressed onto both sides of the first housing portion.

In addition it is provided that pressed into the first housing portion is a pot-like cylindrical second housing portion, on which a valve spring for the valve element is supported. The second housing portion is thus designed substantially rotationally symmetrical, corresponding to the first housing portion. The first and the second housing portions can therefore easily be pressed together, wherein before pressing in, a valve element and a valve spring belonging to the valve element are inserted between the two housing portions. Thus production of the quantity control valve can be simplified and tolerances minimized.

A further embodiment of the invention provides that the first housing portion has at least one axial groove through which fuel can flow axially between the first housing portion and the second housing portion and/or a further housing portion. Through the at least one axial groove, the exchange of fuel can take place which is necessary for the function of the quantity control valve, without additional elements or complicated forming being required. Thus where applicable the second housing portion can be designed more simply and produced economically.

The quantity control valve is further improved if it comprises a hardened stop ring for the valve element, which ring is pressed into the second housing portion.

Thus the second housing portion can be made of a comparatively soft material, for example by means of deep drawing and/or punching, wherein by means of the hard stop ring a nonetheless a wear-resistant stop of the valve element is created. The second housing portion can thus be produced comparatively simply and economically, but nonetheless can be pressed together with the first housing portion by means of the axially extending connecting segments.

Example embodiments of the invention are described below with reference to the drawing. The drawing shows:

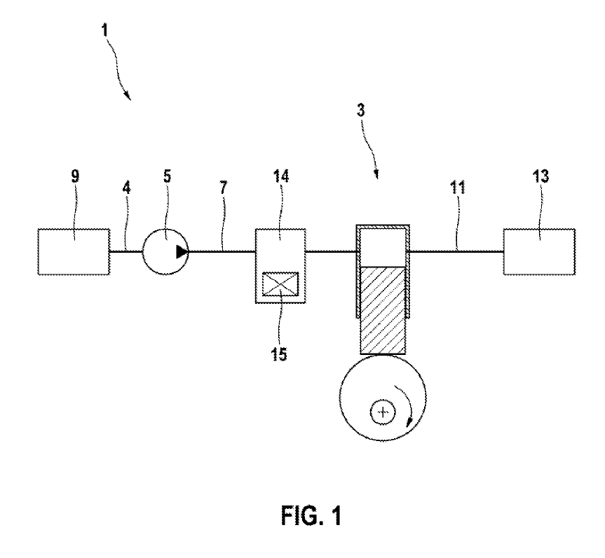

FIG. 1 a diagram of a fuel system of an internal combustion engine;

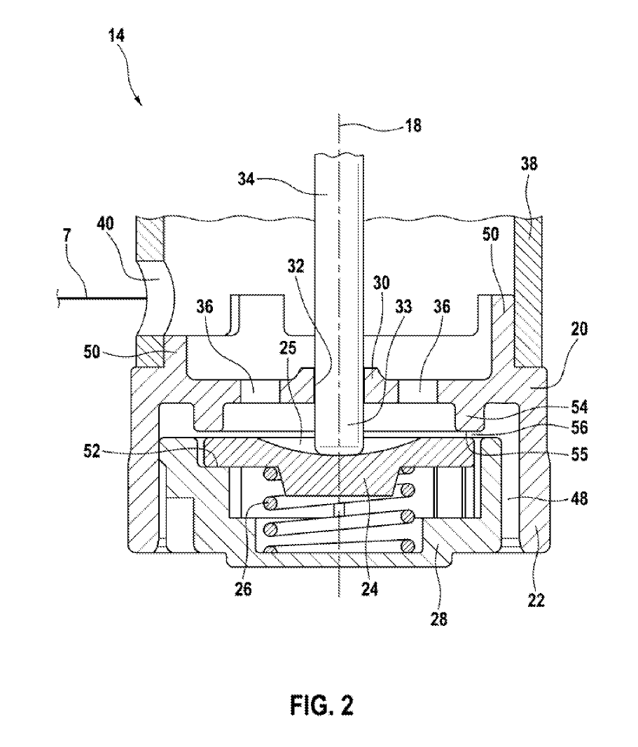

FIG. 2 a partial depiction of a first embodiment of a quantity control valve of the fuel system in FIG. 1 in a side view;

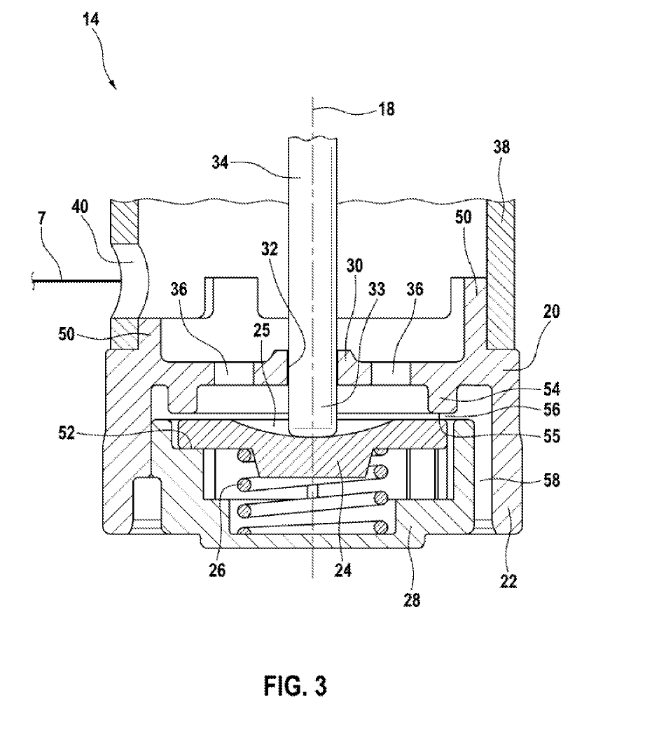

FIG. 3 a partial depiction of a second embodiment of the quantity control valve in a section view; and

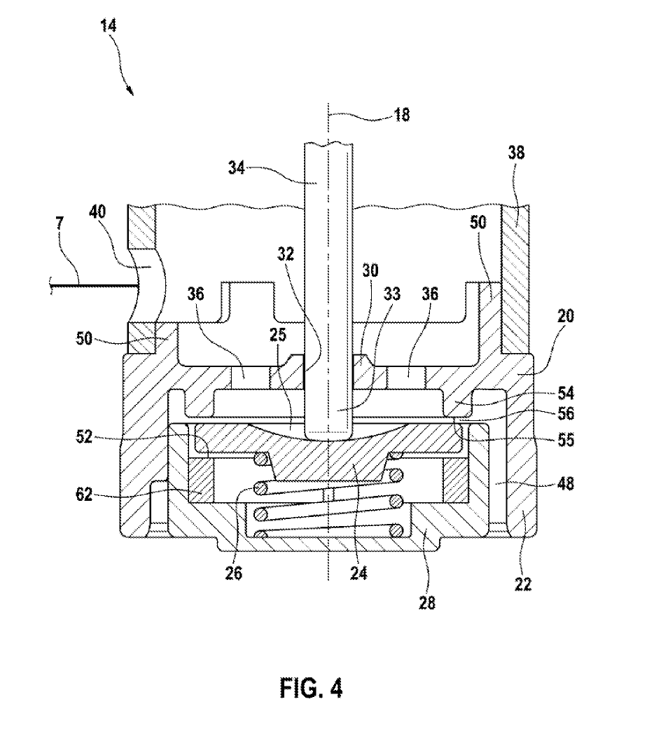

FIG. 4 a partial depiction of a third embodiment of the quantity control valve in a section view.

In all figures, even in different embodiments, the same reference numerals are used for elements and variables of equivalent function.

FIG. 1 shows a fuel system 1 of an internal combustion engine in a greatly simplified depiction. Fuel is supplied from a fuel tank 9 via a suction line 4 by means of a pre-delivery pump 5, via a low pressure line 7 and via a quantity control valve 14 which can be actuated by a solenoid 15, to a high pressure pump 3 (not explained further here). Downstream, the high pressure pump 3 is connected via a high pressure line 11 to a high pressure accumulator 13 (“common rail”). Other elements such as for example valves of the high pressure pump 3 are not shown in FIG. 1. Evidently the quantity control valve 14 can be formed as an assembly with the high pressure pump 3. For example the quantity control valve 14 can be a forced-opening inlet valve of the high pressure pump 3. Also the quantity control valve 14 can have an actuating device other than the solenoid 15, for example a piezo-actuator or a hydraulic actuation.

In operation of the fuel system 1, the pre-delivery pump 5 delivers fuel from the fuel tank 9 into the low pressure line 7. Here the quantity control valve 14 determines the fuel quantity supplied to a working chamber of the high pressure pump 3.

FIG. 2 shows a partial view of the quantity control valve 14 in a section view. The quantity control valve 14 is designed substantially rotationally symmetrical about a longitudinal axis 18. In the middle of FIG. 2 is arranged a first housing portion 20. The first housing portion 20 has an approximately pot-like cylindrical form and comprises a cylindrical wall segment 22 in the lower region of the drawing. In the volume formed radially inward from the cylindrical wall segment 22 are coaxially arranged a plate-like valve element 24, a valve spring 26 and a second housing portion 28. The second, also cylindrical, housing portion 28 is pressed into the wall segment 22 of the first housing portion 20. Here the valve spring 26 is supported on the second housing portion 28.

Furthermore the first housing portion 20 comprises a guide segment 30 present in a floor (without reference numeral) of the pot-like first housing portion 20, with a central opening 32 in which is radially guided an end segment 33 of an axially moveable actuating element 34. The end segment 33 presses the valve element 24 into a spherical cap-shaped recess 25 of the valve element 24. Through the passage openings 36 produced as bores in the floor of the first housing portion 20, fuel can be exchanged between an upper and a lower region (in the drawing) of the first housing portion 20. Above the first housing portion 20 in the drawing is arranged a third housing portion 38. The third housing portion 38, in the left part of FIG. 2, has an opening 40 which is connected with the low pressure line 7. Radially between the first housing portion 20 and the second housing portion 28, distributed over the circumference of the latter, are formed several channels 48 through which fuel can flow in the axial direction.

Furthermore the first housing portion 20 has several stud-like connecting segments 50 which extend axially upwards in FIG. 2, by means of which a press joint to the second housing portion 28 can be produced. The connecting segments 50 are designed such that a suitable ratio is achieved between the diameter of the first housing portion 20 and the axial length of the press joint. On its lower side in the drawing, the first housing portion 20 has an axially extending annular web 54 which forms a valve seat 55 for the valve element 24.

In operation, the quantity control valve 14 can assume two states. In an open state shown in FIG. 2, the actuating element 34 presses the valve element 24 downward in the drawing and presses this against a substantially annular stop 52 of the second housing portion 28. An annular gap 56 is thus created between the valve element 24 and the annular web 54 of the first housing portion 20. Through this gap, fuel can flow back into the working chamber of the high pressure pump 3, or in the reverse direction, from the low pressure line 7, the opening 40, the passage openings 36, the annular gap 56 and the channels 48.

In a blocked state of the quantity control valve 14 not shown in FIG. 2, the actuating element 34 is raised upward in the drawing at least so far from the valve element 24 that the valve element 24 can be pressed by the force of the valve spring 26 against the annular web 54. Thus the quantity control valve 14 is blocked and no fuel can flow between the channels 48 and the opening 40.

The first housing portion 20 is produced integrally in a powder injection molding process. It is known that the first housing portion 20, as already described above, performs several different functions. Firstly in portions it forms part of the housing of the quantity control valve 14, or a carrier for the further housing portions 28 and 38. Secondly by means of the passage openings 36 and the channels 48, it forms flow channels for the fuel. Thirdly it forms the guide segment 30 for the actuating element 34 with the central opening 32, and fourthly by means of the annular web 54 it forms the valve seat 55 for the valve element 24.

In the present case the integrally produced first housing portion 20 replaces, inter alia, two press joints which would otherwise be necessary. In particular no press joint is required between an element forming the guide segment 30 and a carrier element because of the integral design of the first housing portion 20. Thus the actuating element 34 can be guided without additional tolerance and any non-coaxial orientation of the actuating element 34 (“needle skew”) can be avoided. Furthermore the first housing portion 20 can be produced with such precise dimensions such that the central opening 32 need not be reworked.

FIG. 3—based on FIG. 2—shows a further embodiment of the quantity control valve 14. In addition in FIG. 3 the channels 48 are produced by means of grooves 58 (“flow grooves”) on the first housing portion 20, through which fuel can flow axially between the wall segment 22 of the first housing portion 20 and a radially outer delimiting face of the second housing portion 28. The other segments of the quantity control valve 14 in FIG. 3 are similar or identical to those in FIG. 2.

FIG. 4—again based on FIGS. 2 and 3—shows yet another embodiment of the quantity control valve 14. The second housing portion 28 is designed again as a pot and is made of a comparatively soft material by means of a deep-drawing process and/or a punching process. Pressed into the second housing portion 28 is a stop ring 62 which is made from a comparatively hard material or is hardened. Thus the valve element 24 can stop in the open position and rest on the stop ring 62 in a defined manner.

1. A quantity control valve of a fuel system, comprising:
an actuating element;
a valve element configured to be urged by the actuating element against a force of a valve spring;
at least one first housing portion, including (i) a guide segment integrally formed on the at least one first housing portion and configured to guide the actuating element, and (ii) a valve seat integrally formed on the at least one first housing portion and configured to cooperate with the valve element,
wherein the at least one first housing portion is produced integrally with the guide segment and the valve seat by powder injection molding.

2. The quantity control valve as claimed in claim 1, wherein:
the at least one first housing portion has a pot-like cylindrical shape, and
the guide segment is located at a central opening defined in a floor of the at least one first housing portion.

3. The quantity control valve as claimed as in claim 2, wherein passage openings for a fuel are defined in the floor of the first housing portion.

4. The quantity control valve as claimed in claim 1, wherein the valve seat includes an axially extending annular web.

5. The quantity control valve as claimed in claim 1, wherein the at least one first housing portion includes at least one axially extending connecting segment to create at least one press joint connecting the at least one first housing portion with at least one second housing portion.

6. The quantity control valve as claimed in claim 1, further comprising:
a pot-like cylindrical second housing portion press-fit into the at least one first housing portion, and
wherein the valve spring for the valve element is supported on the pot-like cylindrical second housing portion.

7. The quantity control valve as claimed in claim 6, wherein the at least one first housing portion includes at least one axial groove through which a fuel flows axially between the at least one first housing portion and at least one of the pot-like cylindrical second housing portion and a further housing portion.

8. The quantity control valve as claimed in claim 6, further comprising:
a hardened stop ring for the valve element,
wherein the hardened stop ring is press-fit into the second housing portion.

9. A method of producing a quantity control valve of a fuel system having an actuating element, a valve element configured to be urged by the actuating element against a force of a valve spring, and at least one first housing portion including (i) a guide segment integrally formed on the at least one first housing portion and configured to guide the actuating element, and (ii) a valve seat integrally formed on the at least one first housing portion and configured to cooperate with the valve element, the method comprising:
forming the at least one first housing portion integrally with the guide segment and the valve seat by powder injection molding.
